(19) United States
(12) Patent Application Publication
(10) Pub. No.: US 2025/0086407 A1
(43) Pub. Date: Mar. 13, 2025

(54) LARGE LANGUAGE MODEL DATA OBJECT GENERATION

(71) Applicant: Salesforce, Inc., San Francisco, CA (US)

(72) Inventors: Sundar Ram Vedula, Bangalore (IN); Rajdeep Dua, Hyderabad (IN); Akash Singh, Hyderabad (IN); Manoj Kumar Subramaniyan, Bangalore (IN); Ankit Oberoi, Hyderabad (IN); Ajay Singh, Bangalore (IN); Arpit Trivedi, Hyderabad (IN)

(21) Appl. No.: 18/412,078

(22) Filed: Jan. 12, 2024

(30) Foreign Application Priority Data
Sep. 11, 2023 (IN) 202341061091

(51) Int. Cl. G06F 40/58; G06Q 30/0203

(52) U.S. Cl. CPC G06F 40/58; G06Q 30/0203

(57) ABSTRACT

Methods, apparatuses, systems, and computer-program products are disclosed. For example, a system may receive, via a cloud-based platform, first user input including a request for generation of the output data object. The system may generate a prompt based on the first user input and a prompt appendix that defines a response format for a plurality of responses to the prompt that are to be generated by a large language model (LLM). The system may transmit the prompt to the LLM and may receive, from the LLM, the plurality of responses formatted in the response format. The system may generate the output data object that comprises the plurality of responses.

### CROSS REFERENCE

The present application for patent claims the benefit of and priority to Indian Patent Application number 202341061091 by Vedula et al., entitled “LARGE LANGUAGE MODEL DATA OBJECT GENERATION,” filed Sep. 11, 2023, assigned to the assignee hereof, and is expressly incorporated by reference in its entirety herein.

### FIELD OF TECHNOLOGY

The present disclosure relates generally to database systems and data processing, and more specifically to large language model data object generation.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some cloud platform scenarios, the cloud platform, a server, or other device may be used to create surveys or other data objects for use. However, such methods may be improved.

### BRIEF DESCRIPTION OF THE DRAWINGS

FIG. 1 illustrates an example of a generating an output data object system that supports large language model data object generation in accordance with aspects of the present disclosure.

FIG. 2 shows an example of a system that supports large language model data object generation in accordance with aspects of the present disclosure.

FIG. 3 shows an example of a data object generation scheme that supports large language model data object generation in accordance with aspects of the present disclosure.

FIG. 4 shows an example of a process flow that supports large language model data object generation in accordance with aspects of the present disclosure.

FIG. 5 shows a block diagram of an apparatus that supports large language model data object generation in accordance with aspects of the present disclosure.

FIG. 6 shows a block diagram of a data object manager that supports large language model data object generation in accordance with aspects of the present disclosure.

FIG. 7 shows a diagram of a system including a device that supports large language model data object generation in accordance with aspects of the present disclosure.

FIGS. 8 through 10 show flowcharts illustrating methods that support large language model data object generation in accordance with aspects of the present disclosure.

### DETAILED DESCRIPTION

The rapid advancement of artificial intelligence (AI) and machine learning (ML) has led to the development of increasingly sophisticated natural language processing (NLP) techniques, including large language models (LLMs). These models have been utilized for a variety of tasks, including translation, text generation, sentiment analysis, and more. However, some approaches utilizing LLMs and other AI do not sufficiently bridge the gap between high-level user intents and the execution of corresponding tasks in various tools and systems. For example, such systems or approaches may not be suitable for generating surveys for customers, clients, users, businesses, or other entities.

In accordance with examples as disclosed herein, and to resolve one or more of the described problems with utilizing LLMs, a system is described that can leverage the generative capabilities of an LLM while ensuring accuracy of the data within the responses. For example, the system may generate an initial prompt for the LLM based on user input that may designate characteristics of the desired output data object. For example, if the output data object is to be a survey, the user input may designate a quantity of questions, an overall survey type, other survey characteristics, or any combination thereof. The system may also append the prompt with additional information used to “ground” or orient the LLM to produce more focused and applicable results. Such grounding information may describe, for example, an output format in which the LLM is to format the responses to the query. The system may transmit the appended query to the LLM and receive one or more responses from the LLM (e.g., which may include survey questions to be included in the final output survey). The received responses may be converted from the output format to another format for presentation in a user interface (UI), after which the final output data object (e.g., a final survey) may be produced based on the converted responses.

At various stages, the system may accept user input to customize one or more aspects of the data object generation process. For example, the system may generate a first query, but the user may add, remove, or modify one or more elements of the query to customize the query. Further, the system may transmit the converted responses to the user and the user may modify the converted responses as appropriate before they are compiled or assembled into the output data object. For example, the user may provide user input that may map one or more responses to one or more response types (e.g., survey question types) that may aid in the generation of the output data object (e.g., the final version of the survey).

Aspects of the disclosure are initially described in the context of an environment supporting an on-demand database service. Aspects of the disclosure are then described with reference to a system, a data object generation scheme, and a process flow: Aspects of the disclosure are further illustrated by and described with reference to apparatus diagrams, system diagrams, and flowcharts that relate to large language model data object generation.

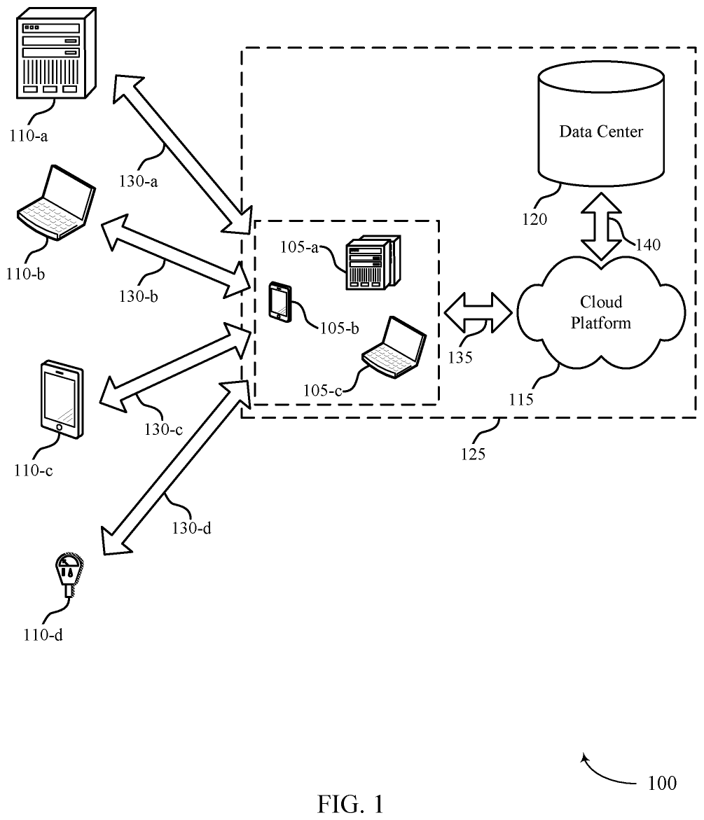

FIG. 1 illustrates an example of a system 100 for cloud computing that supports large language model data object generation in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

For example, a cloud client 105 may transmit user input to the cloud platform 115 to initiate creation of the output data object. The user input may include a request to generate the output data object (e.g., a survey). The cloud platform 115 may generate a prompt that the LLM may use to generate one or more responses (e.g., survey questions) that may be included in the final output data object. The cloud platform 115 may append additional information to the prompt to ground the prompt so that the information sent to the LLM may be interpreted more correctly and the output responses and eventual output data object may be better tuned to produce the output specified in the prompt. For example, the prompt may be appended to include an output format in which the responses are to be delivered from the LLM. The could platform 115 may transmit the prompt to the LLM (which may be an LLM hosted within or associated with the cloud platform or may be an LLM external to the cloud platform 115) and the LLM may respond with the responses (e.g., the survey questions) in the specified output format. The cloud platform 115 may convert the responses to a format for additional processing (e.g., mapping survey questions to different survey types), presentation within the UI, and ultimate compilation or assembly into the output data object (e.g., a survey that may then be sent to clients, customers, users, etc.).

Some approaches to using LLMs do not account for the particular requests that a user may make. For example, a general LLM may be overly broad and may lack some information that may be useful for generating the responses requested by the user. Further, the responses provided by such LLMs may not be formatted correctly (e.g., for additional processing by a system) or may not include types of information or metadata that would otherwise improve the quality and accuracy of the responses provided by the LLM and the resulting output data objects created based on the responses.

Thus, the systems and approaches described herein include grounding information, instructions, or processes that increase the accuracy of the LLMs and provide outputs that are more suited to the requests made by users. Such grounding information is included in the prompt that is sent to the LLM so that the LLM, despite perhaps lacking some domain-specific information, may provide responses that better match the user's inputs. Further, the grounding information may also include a desired output format for the responses, such that the information output by the LLM may be converted or imported into the system for additional processing, modification through user input, metadata mapping, other processes, or any combination thereof.

For example, a user may provide a request to a system, requesting generation of a survey. The user may designate or identify desired characteristics of the final survey, such as a quantity of questions, question types, an overall survey type, a related industry or domain, one or more additional characteristics of the survey, or any combination thereof. The system may generate a prompt that may include such information which may be modified as indicated by the user (e.g., to change a product that is to be the subject of the survey or to provide additional information for increased accuracy or relevance of the responses that are to be produced by the LLM). The system may transmit the prompt to the LLM and receive the output of the LLM. The system may then convert the responses (e.g., that were received in a format designated in the prompt, either by the user or though information appended to the prompt by the system) to a format better suited for additional processing and presentation in a UI. The user may then review the generated responses. For the example, the prompt may have included a request to generate an indication of a question type for each survey question, and the determined question type may be presented to the user alongside the actual question. The user may then modify the question type to a related question type determined by the LLM or may leave the selection on the question type determined by the LLM. The user may then submit a request for generation of the compiled or assembled survey, that may include the responses generated by the LLM and formatted according to the question type selected by the user. This resulting output data object may then be sent to customers, clients, users, or others that are to provide information via the survey.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

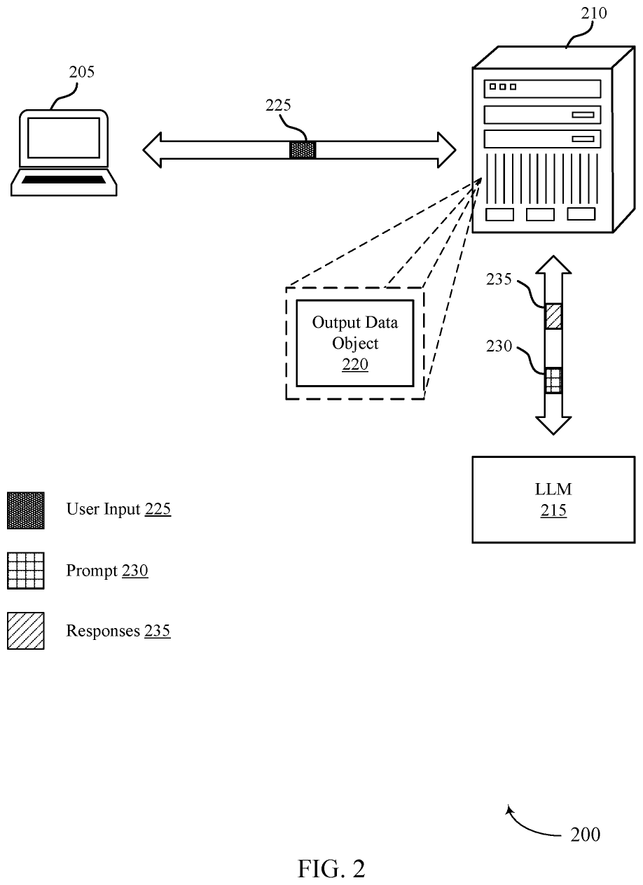

FIG. 2 shows an example of a system 200 that supports large language model data object generation in accordance with aspects of the present disclosure. The system 200 includes a client 205, a server 210, and an LLM 215. The LLM 215 may be hosted locally on the server 210 or within the same system (e.g., a cloud-based platform) as the server 210. Additionally, or alternatively, The LLM 215 may be hosted elsewhere and may be accessed by the server 210. The server 210 depicted here may represent one or more servers that may function in concert (e.g., in a distributed processing environment or a cloud-based platform).

In some examples, the client 205 may transmit the user input 225 to the server 210. The user input 225 may include a request for the server 210 to generate the output data object 220, which may be a survey that is to be distributed to customers, clients, or others whose feedback may be desired. However, in some examples, the output data object may not be a survey and may instead be a different type of data object. The approaches herein may be applied to various different types of data objects and are not limited to the example discussions of surveys described herein.

The server 210 may (e.g., as part of the process of generating the prompt 230) append information to the prompt 230 that may aid in grounding the prompt to provide additional parameters or information with which the LLM 215 may generate the responses 235. For example, the server 210 may append an indication of a response format or the structure of such a response format in which the LLM 215 is to provide the responses 235. For example, the information appended to the prompt 230 may include an example of a response which may form a pattern according to which the LLM 215 may generate the responses 235. Additionally, or alternatively, the information appended to the prompt 230 may include an indication of a response format designed elsewhere (e.g., that is accessible by the LLM 215). Such additional information may increase the accuracy or suitability of the responses 235 generated by the LLM 215, despite the LLM 215 being, in some cases, a broad-spectrum LLM trained on wide-ranging types of data.

The server 210 may then transmit the prompt 230 to the LLM 215 for the LLM 215 to generate the responses 235. The responses 235 may, in some examples, be survey questions for a survey, which may be an example of an output data object 220. The responses 235 may be generated by the LLM 215 using the information in the prompt, such as the characteristics of the output data object 220 as a whole, characteristics of individual responses 235, the additional grounding parameters or information, modifications to the prompt made by the user (e.g., through additional user input 225), one or more rules or procedures for generating the output data object 220 that may be stored or accessed by the server 210, or any combination thereof. The server 210 may then receive the responses from the LLM 215 and the responses may formatted in the output format indicated or provided in the prompt.

Additional processing or operations may be performed based on the received responses 235. For example, the server 210 may compile the responses into the output data object 220 (e.g., optionally including a process of converting the responses from the output data format used by the LLM 215 to another format that may be better suited for processing or interconnection with one or more services, applications, processing layers, or other elements of the systems described herein). The compiled or assembled output data object 220 may then be provided to another system for distribution to customers, clients, users, employees, or others whose information may be desirable to collect (e.g., in the case of a survey).

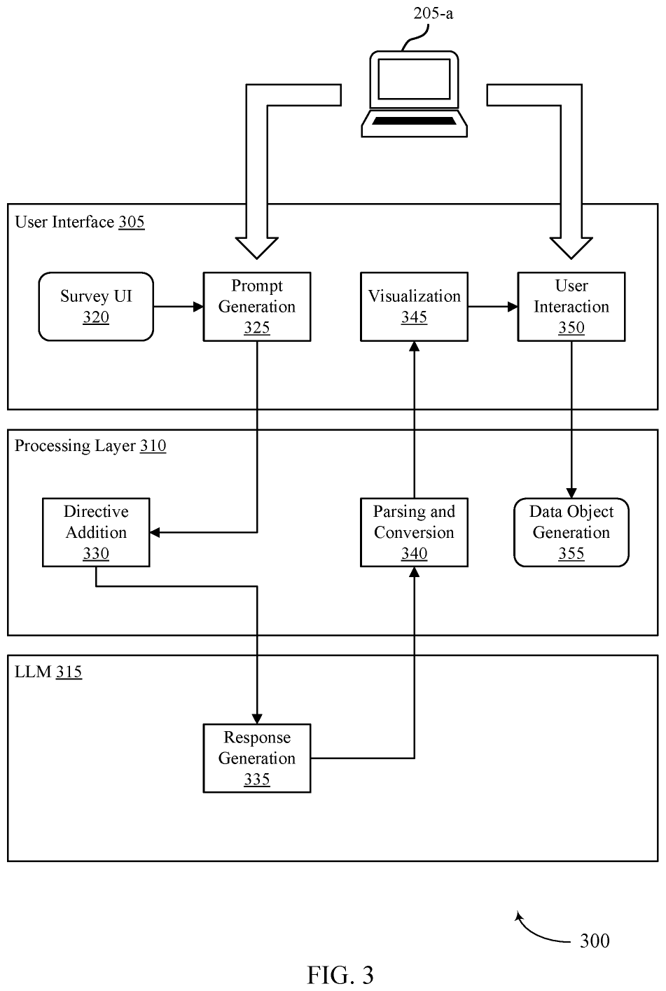

FIG. 3 shows an example of a data object generation scheme 300 that supports large language model data object generation in accordance with aspects of the present disclosure.

In some examples, the data object generation scheme 300 may involve various divisions, elements, or layers that may be used to perform different functions associated with generation of an output data object. For example, the data object generation scheme 300 may include the user interface 305, the processing layer 310, the LLM 315 (which may be locally hosted or externally hosted), one or more other elements, or any combination thereof. Though an example of survey generation is described in relation with FIG. 3, other output data objects may be generated with the same processes, and the survey generation is only one example of the use of the subject matter described herein. Though some operations or elements may be associated with portions of the data object generation scheme 300 (e.g., the user interface 305, the processing layer 310, or the LLM 315), it is to be understood that any of the operations or processes described herein may be performed by any of the elements of the data object generation scheme 300 or multiple such elements.

In some examples, the client 205-a may access the user interface 305, which may include the survey UI 320, which may present options to the client 205-a for generating the final survey. For example, the survey UI 320 may present selectable options for the user to select a type of survey, a quantity of questions for the survey, one or more metrics that the survey may be designed to measure (e.g., a net promoter score metric, a customer satisfaction metric, a rating metric, one or more other metrics, or any combination thereof), one or more associated industries, one or more associated regions (e.g., geographic regions), an output language (e.g., that may be different than the input language, where such an instruction may indicate that the LLM 315 is to translate the responses to the output language), one or more other characteristics of the survey, or any combination thereof.

The system may engage in the prompt generation 325, which may include generating the prompt that is to be transmitted to the LLM 315 for generation of the responses (which, in this example, may be survey questions). The prompt may include one or more elements of the characteristics or information that were selected by the user through the survey UI 320. The prompt may be formatted in one or more aspects to conform with an input format that may be expected by the LLM 315. For example, the prompt may be formatted in a plain text input format, a structured data format (e.g., including one or more fields associated with one or more features of the LLM 315), one or more other formats, or any combination thereof. Once this prompt is generated, it may be presented to the client 205-a for modification by the user. For example, the user may modify one or more elements of the prompt (e.g., altering the prompt to describe a particular product or products) and may further add additional parameters or instructions to further customize the generation of the survey (e.g., to better suit the aims of the user in producing the survey). For example, the user may include an instruction that the responses not exceed a length threshold (e.g., 300 characters). Additionally, or alternatively, such a parameter may be automatically generated during the prompt generation 325.

In some examples, the processing layer 310 may engage in the directive addition 330 to provide additional parameters or information that may aid in grounding the LLM 315 to provide more accurate or relevant responses (e.g., survey questions) or reduce or eliminate potential bias in the responses. For example, the directives added or appended to the prompt may include an output format for the responses that may be compatible with the processing layer 310. Such directives may include an indication of such a format or an example of such a format. For example, such a format may be a JSON format, an XML format, one or more other formats, or any combination thereof. In some examples, such a format may include one or more fields, including a response name field, a response type field, a help text field, an optionality field, or any combination thereof.

In some examples, the directives added or appended may include additional instructions for the LLM 315. For example, the directives may include an instruction for the LLM 315 to determine one or more response types (e.g., survey question types) for each of the responses (e.g., survey questions) that are to be generated by the LLM 315. Additionally, or alternatively, such instructions may further include one or more response types or question types from which the LLM 315 is to select when determining the response types for each of the responses. Additionally, or alternatively, the instructions may include an instruction for the LLM 315 to map the generated responses to one or more of the indicated response types as a default or primary response type as well as one or more related response types (e.g., from which the user may select during the user interaction 350). In some examples, survey question types or response types may include an attachment upload type, a date selection type, a like/dislike type, a long text entry type, a matrix type, a multiple selection type, a net promoter score type, a picklist type, a ranking type, a rating type, a score type, a short text entry type, a single selection type, a slide type, one or more other question or response types, or any combination thereof. In some examples, the instructions may include an instruction for the LLM 315 to generate or determine one or more characteristics or metadata associated with the responses that are also to be presented alongside the responses to the user (e.g., during the visualization 345, the user interaction 350, or both, via the user interface 305).

The processing layer 310 may transmit the prompt (e.g., including any user modifications, any prompt additions made at the processing layer 310, or both) to the LLM 315. The LLM 315 may engage in the response generation 335, in which the LLM 315 generates the responses based on the prompt.

In some examples, the LLM 315 may be a publicly-accessible LLM or an externally-hosted LLM (e.g., outside of a cloud platform in which the user interface 305 and the processing layer 310 may operate). However, in some examples, the LLM 315 may be hosted within such a cloud platform or otherwise be associated with the processing layer 310, the user interface 305, the client 205-a, or any combination thereof. In such cases, the LLM 315 may be trained, tuned, or both using information associated with the cloud platform. For example, the LLM 315 may be trained, tuned, or both on feedback data associated with prior surveys which may express applicability, usefulness, or other information about such prior surveys which may be incorporated into the LLM 315 to provide more accurate results when generating new responses. For example, a customer or client that generated a survey may respond to questions about the survey itself and how applicable, accurate, or helpful the survey was for the desired purposes. Such feedback information may be collected for each survey that is generated and delivered to a requestor and the feedback information may be stored in a repository that may be used to train and/or tune the LLM 315. Regardless of whether the LLM 315 is an externally-hosted LLM, an internally-hosted LLM, a locally-hosted LLM, a custom-generated LLM, or any combination thereof, the LLM 315 may be trained, refined, or both with such feedback information to improve the LLM 315 and the quality of the responses generated by the LLM 315.

In some examples, the LLM 315 may be trained or modified (e.g., tuned) for a particular client, customer, organization, industry, or other classification to provide characteristics of the output data objects (e.g., surveys) that may be more suited for the particular client, organization, or industry. Further, as more and more output data object (e.g., survey's) are created and feedback on such data objects is collected (e.g., relevancy feedback, accuracy feedback, or other feedback), the training data may be improved by including domain-specific information along with positively-received and negatively-received examples of elements of data objects. In some examples, such information may be siloed or divided as to avoid contamination or leakage of information between different clients or users of a cloud platform performing the operations described herein. Further, in some examples, the LLM 315 may be trained on existing client data or information collected from other sources.

In some examples, the LLM 315 may be a custom built LLM that is trained, tuned, and constructed for generating output data objects, such as surveys, within or in association with the cloud-based platform. For example, such an LLM 315 may be trained on example surveys, survey feedback data, tagged or marked information relating to surveys, customer-specific information, customer relations management (CRM) software information, or any combination thereof. Further

In some examples, the LLM 315 may also translate the responses to another language (e.g., to provide surveys to different language speakers). In some examples, the translation may be performed in light of other information (e.g., customer information or training data) that may improve the accuracy of the translation (e.g., for particular industries or other domain-specific information). In some examples, the translation may be performed on a page-by-page basis, on a response-by-response basis, or on another basis. In some examples, the user may designate different translation options (e.g., language, translation method or basis, regional dialects, formality options, style options, one or more other translation characteristics, or any combination thereof) in the prompt and the LLM 315 may then translate the responses based on such translation options.

The LLM 315 may transmit the response back to the processing layer 310 and the processing layer 310 may engage in the parsing and conversion 340, which may include parsing of the responses to extract the data from the responses, conversion of the responses to a different format, or both. For example, the processing layer 310 may receive the response formatted in the format designated in the prompt, which may aid in the extraction of the information from the responses (e.g., as different elements of the responses or associated metadata may be tagged or associated with different data types, which may aid in the construction or assembly of the output data object, such as a survey). For example, the responses may include the survey questions, a question type, one or more related question types, one or more other parameters for building the output survey, or any combination thereof. The processing layer 310 may parse and convert such information (e.g., based on the mapping or tagging of the various elements of the responses) to another format that may be accepted by the user interface 305 for the visualization 345 of the responses at the user interface 305.

At the visualization 345, the user interface 305 may present the various responses and additional associated information to the user to allow the user to edit the responses before final compilation or assembly into the output data object (e.g., a survey). For example, the user interface 305 may present the various survey questions generated by the LLM 315, an option to include or exclude individual survey questions, an indication of the question type determined by the LLM 315, other information, or any combination thereof. During the visualization 345, the user interface 305 may also present the prompt that was used by the LLM 315 to generate the responses (e.g., which may include or exclude the additional information added to the prompt during the directive addition 330).

Further, the user may modify some or all of the information presented during the visualization 345 during the user interaction 350. For example, the user may change the default or initially-selected question type of one or more survey questions to a different question type, and may select from a set of related question types that were determined by the LLM 315. In some examples, other characteristics or metadata associated with the responses may be altered by the user during the user interaction 350. In some examples, by modifying or adding information, the user may affect a manner of presentation of the output data object (e.g., the survey). For example, by selecting a different survey question type, the manner of collecting the information may change from a text field where a survey taker would type a rating from 1 to 10, to a rating interface that may involve clicking on a particular rating from a selection of ratings. The user may further include additional user-created responses (survey questions) may be added to the group of the LLM-generated responses and may further edit or remove one or more of the LLM-generated responses, associated characteristics (e.g., metadata), or both.

The user may further transmit an instruction (e.g., via the user interface 305) to generate the output data object (e.g., the survey) based on the information presented in the user interface 305 during the visualization 345 and the user interaction 350. The processing layer 310 may then generate the output data object during the data object generation 355 and may do so based on the responses, metadata, and other information presented in the visualization 345 and modified through the user interaction 350. At such a point, the output data object (e.g., the survey) may be available for the user to send or deploy at various locations (e.g., to send to clients or users to collect survey information).

In this way, the accuracy and suitability of the survey may be increased at least through the increased grounding and instructions provided to the LLM 315, reducing hallucinations, errors, or other undesired results that might otherwise result from using the LLM 315.

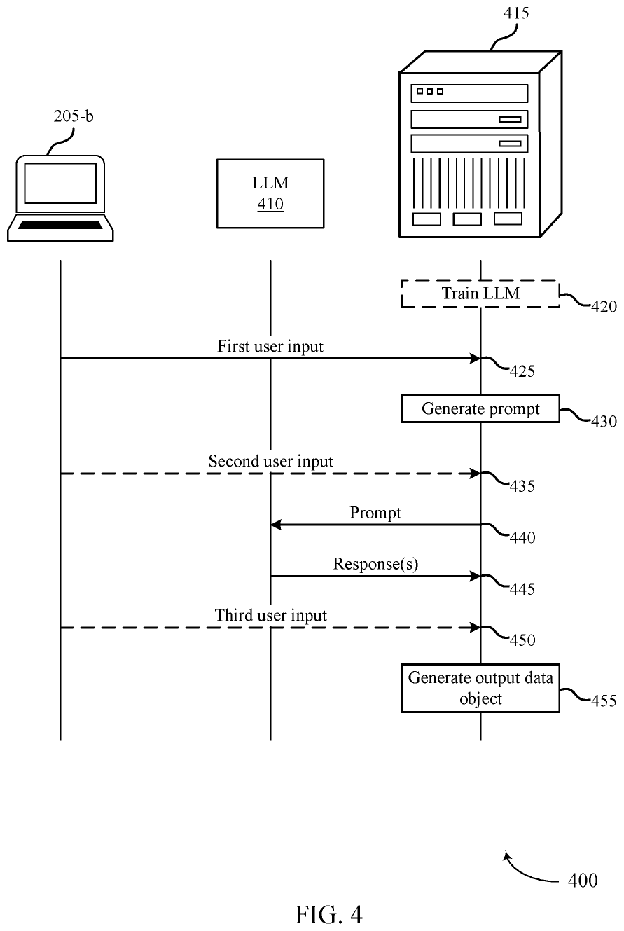

FIG. 4 shows an example of a process flow 400 that supports large language model data object generation in accordance with aspects of the present disclosure. The process flow 400 may implement various aspects of the present disclosure described herein. The elements described in the process flow 400 (e.g., application server 415, LLM 410, and client 205-b) may be examples of similarly named elements described herein.

In the following description of the process flow 400, the operations between the various entities or elements may be performed in different orders or at different times. Some operations may also be left out of the process flow 400, or other operations may be added. Although the various entities or elements are shown performing the operations of the process flow 400, some aspects of some operations may also be performed by other entities or elements of the process flow 400 or by entities or elements that are not depicted in the process flow, or any combination thereof.

At 420, the application server 415 may train the LLM 410 with training data that may include feedback information associated with previously-generated output data objects, a plurality of translations of previously-generated output data objects, customer data, customer relationship management software data, or any combination thereof. The LLM 410 may be an LLM hosted on the application server 415 or another device associated with the application server 415 (e.g., in a system associated with the application server 415, such as a cloud-based platform). In some examples, the LLM 410 may be hosted on a different device or system (e.g., hosted on another platform).

At 425, the application server 415 may receive, via a cloud-based platform, first user input that may include a request for generation of the output data object. In some examples, the first user input further may include an indication of an output data object type, an indication of a quantity of requested responses, an indication of one or more metrics associated with the plurality of responses, an indication of an industry to be associated with the plurality of responses, an indication of a geographic region to be associated with the plurality of responses, or any combination thereof.

At 430, the application server 415 may generate a prompt based on the first user input and a prompt appendix that defines a response format for a plurality of responses to the prompt that are to be generated by a large language model (LLM 410). In some examples, the response format may include a response name field, a response type field, a help text field, an optionality field, or any combination thereof. In some examples, the prompt appendix may include a plurality of response types and a request to map each of the plurality of responses to one or more response types of the plurality of response types. In some examples, the prompt may indicate a target language to which the plurality of responses is to be translated by the LLM 410.

At 435, the application server 415 may receive second user input modifying the prompt.

At 440, the application server 415 may transmit the prompt to the LLM 410.

At 445, the application server 415 may receive, from the LLM 410, the plurality of responses formatted in the response format. In some examples, the plurality of responses comprise information expressed in the target language. In some examples, the plurality of responses may include survey questions, the output data object may include a survey data object, or both.

At 450, the application server 415 may receive third user input that may include one or more indications of one or more response types of a plurality of response types corresponding to individual responses of the plurality of responses and the one or more response types are to be associated with the corresponding individual responses in the output data object. In some examples, the plurality of response types may include a single selection response type, a multiple selection response type, a picklist response type, a net promoter score response type, a customer satisfaction response type, a text entry response type, or any combination thereof.

At 455, the application server 415 may generate the output data object that may include the plurality of responses. In some examples, generating the output data object may include converting the plurality of responses from the response format indicated in the prompt to a data format corresponding to the output data object and converting the plurality of responses is based on a mapping between elements of the response format and elements of the data format corresponding to the output data object.

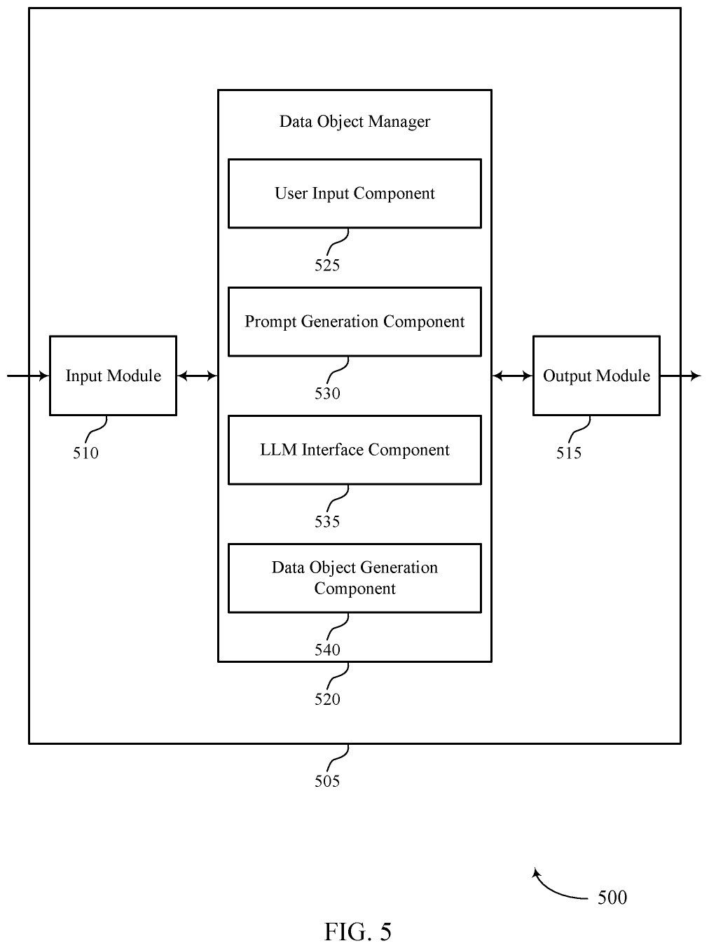

FIG. 5 shows a block diagram 500 of a device 505 that supports large language model data object generation in accordance with aspects of the present disclosure. The device 505 may include an input module 510, an output module 515, and a data object manager 520. The device 505, or one of more components of the device 505 (e.g., the input module 510, the output module 515, and the data object manager 520), may include at least one processor, which may be coupled with at least one memory, to support the described techniques. Each of these components may be in communication with one another (e.g., via one or more buses).

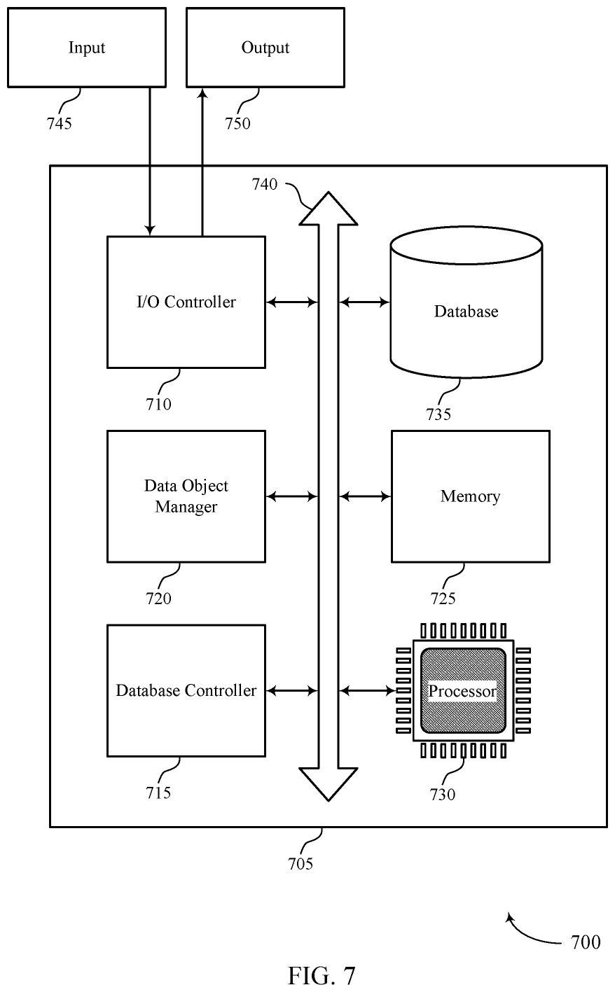

The input module 510 may manage input signals for the device 505. For example, the input module 510 may identify input signals based on an interaction with a modem, a keyboard, a mouse, a touchscreen, or a similar device. These input signals may be associated with user input or processing at other components or devices. In some cases, the input module 510 may utilize an operating system such as iOS®, ANDROID®, MS-DOS®, MS-WINDOWS®, OS/2®, UNIX®, LINUX®, or another known operating system to handle input signals. The input module 510 may send aspects of these input signals to other components of the device 505 for processing. For example, the input module 510 may transmit input signals to the data object manager 520 to support large language model data object generation. In some cases, the input module 510 may be a component of an input/output (I/O) controller 710 as described with reference to FIG. 7.

The output module 515 may manage output signals for the device 505. For example, the output module 515 may receive signals from other components of the device 505, such as the data object manager 520, and may transmit these signals to other components or devices. In some examples, the output module 515 may transmit output signals for display in a user interface, for storage in a database or data store, for further processing at a server or server cluster, or for any other processes at any number of devices or systems. In some cases, the output module 515 may be a component of an I/O controller 710 as described with reference to FIG. 7.

For example, the data object manager 520 may include a user input component 525, a prompt generation component 530, an LLM interface component 535, a data object generation component 540, or any combination thereof. In some examples, the data object manager 520, or various components thereof, may be configured to perform various operations (e.g., receiving, monitoring, transmitting) using or otherwise in cooperation with the input module 510, the output module 515, or both. For example, the data object manager 520 may receive information from the input module 510, send information to the output module 515, or be integrated in combination with the input module 510, the output module 515, or both to receive information, transmit information, or perform various other operations as described herein.

The data object manager 520 may support generating an output data object in accordance with examples as disclosed herein. The user input component 525 may be configured to support receiving, via a cloud-based platform, first user input including a request for generation of the output data object that is to include a set of multiple responses to a prompt. The prompt generation component 530 may be configured to support generating, at a processing layer of the cloud-based platform, the prompt based on the first user input and a prompt appendix that defines a response format for the set of multiple responses to the prompt that are to be generated by a large language model (LLM), the prompt appendix further defining a set of multiple response types to which the LLM is to map individual responses of the set of multiple responses and including an instruction to generate the set of multiple responses in the output data object in accordance with the plurality of response types. The LLM interface component 535 may be configured to support transmitting the prompt from the processing layer to the LLM. The LLM interface component 535 may be configured to support receiving, from the LLM at the processing layer, the set of multiple responses formatted in the response format. The data object generation component 540) may be configured to support generating the output data object that includes the set of multiple responses based on a mapping between one or more elements of the response format and one or more elements of a data format corresponding to the output data object.

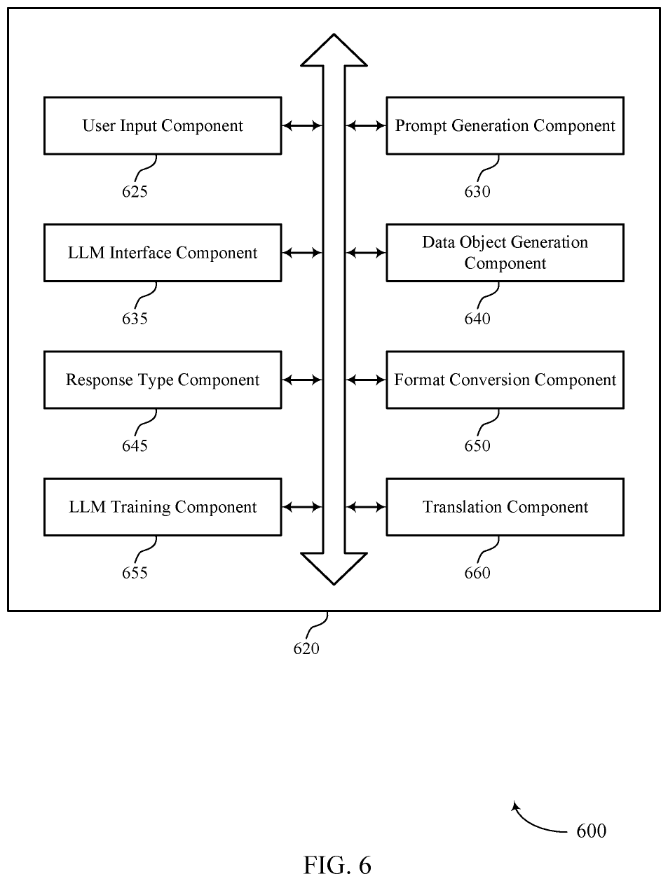

FIG. 6 shows a block diagram 600 of a data object manager 620 that supports large language model data object generation in accordance with aspects of the present disclosure. The data object manager 620 may be an example of aspects of a data object manager or a data object manager 520, or both, as described herein. The data object manager 620, or various components thereof, may be an example of means for performing various aspects of large language model data object generation as described herein. For example, the data object manager 620 may include a user input component 625, a prompt generation component 630, an LLM interface component 635, a data object generation component 640, a response type component 645, a format conversion component 650, an LLM training component 655, a translation component 660, or any combination thereof. Each of these components, or components of subcomponents thereof (e.g., one or more processors, one or more memories), may communicate, directly or indirectly, with one another (e.g., via one or more buses).

The data object manager 620 may support generating an output data object in accordance with examples as disclosed herein. The user input component 625 may be configured to support receiving, via a cloud-based platform, first user input including a request for generation of the output data object that is to include a set of multiple responses to a prompt. The prompt generation component 630 may be configured to support generating, at a processing layer of the cloud-based platform, the prompt based on the first user input and a prompt appendix that defines a response format for the set of multiple responses to the prompt that are to be generated by a large language model (LLM), the prompt appendix further defining a set of multiple response types to which the LLM is to map individual responses of the set of multiple responses and including an instruction to generate the set of multiple responses in the output data object in accordance with the plurality of response types. The LLM interface component 635 may be configured to support transmitting the prompt from the processing layer to the LLM. In some examples, the LLM interface component 635 may be configured to support receiving, from the LLM at the processing layer, the set of multiple responses formatted in the response format. The data object generation component 640 may be configured to support generating the output data object that includes the set of multiple responses based on a mapping between one or more elements of the response format and one or more elements of a data format corresponding to the output data object.

In some examples, the response format includes a response name field, a response type field, a help text field, an optionality field, or any combination thereof.

In some examples, the first user input further includes an indication of an output data object type, an indication of a quantity of requested responses, an indication of one or more metrics associated with the set of multiple responses, an indication of an industry to be associated with the set of multiple responses, an indication of a geographic region to be associated with the set of multiple responses, or any combination thereof.

In some examples, the prompt generation component 630 may be configured to support receiving second user input modifying the prompt.

In some examples, the response type component 645 may be configured to support receiving third user input that includes one or more indications of one or more selected response types of the set of multiple response types corresponding to individual responses of the set of multiple responses, where the one or more selected response types are to be associated with the corresponding individual responses in the output data object.

In some examples, the set of multiple response types includes a single selection response type, a multiple selection response type, a picklist response type, a net promoter score response type, a customer satisfaction response type, a text entry response type, or any combination thereof.

In some examples, generating the output data object includes converting the set of multiple responses to the data format corresponding to the output data object based on the mapping between the one or more elements of the response format and the one or more elements of the data format.

In some examples, the prompt appendix includes a request to map each of the set of multiple responses to one or more response types of the set of multiple response types.

In some examples, the LLM training component 655 may be configured to support training the LLM with training data including feedback information associated with previously-generated output data objects, a set of multiple translations of previously-generated output data objects, customer data, customer relationship management software data, or any combination thereof.

In some examples, the prompt further indicates a target language to which the set of multiple responses is to be translated by the LLM. In some examples, the set of multiple responses include information expressed in the target language.

In some examples, the set of multiple responses includes survey questions, the output data object includes a survey data object, or both.

FIG. 7 shows a diagram of a system 700 including a device 705 that supports large language model data object generation in accordance with aspects of the present disclosure. The device 705 may be an example of or include the components of a device 505 as described herein. The device 705 may include components for bi-directional data communications including components for transmitting and receiving communications, such as a data object manager 720, an I/O controller 710, a database controller 715, at least one memory 725, at least one processor 730, and a database 735. These components may be in electronic communication or otherwise coupled (e.g., operatively, communicatively, functionally, electronically, electrically) via one or more buses (e.g., a bus 740).

The I/O controller 710 may manage input signals 745 and output signals 750 for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. In other cases, the I/O controller 710 may represent or interact with a modem, a keyboard, a mouse, a touchscreen, or a similar device. In some cases, the I/O controller 710 may be implemented as part of a processor 730. In some examples, a user may interact with the device 705 via the I/O controller 710 or via hardware components controlled by the I/O controller 710.

The database controller 715 may manage data storage and processing in a database 735. In some cases, a user may interact with the database controller 715. In other cases, the database controller 715 may operate automatically without user interaction. The database 735 may be an example of a single database, a distributed database, multiple distributed databases, a data store, a data lake, or an emergency backup database.

Memory 725 may include random-access memory (RAM) and read-only memory (ROM). The memory 725 may store computer-readable, computer-executable software including instructions that, when executed, cause at least one processor 730 to perform various functions described herein. In some cases, the memory 725 may contain, among other things, a basic I/O system (BIOS) which may control basic hardware or software operation such as the interaction with peripheral components or devices. The memory 725 may be an example of a single memory or multiple memories. For example, the device 705 may include one or more memories 725.

The processor 730 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 730 may be configured to operate a memory array using a memory controller. In other cases, a memory controller may be integrated into the processor 730. The processor 730 may be configured to execute computer-readable instructions stored in at least one memory 725 to perform various functions (e.g., functions or tasks supporting large language model data object generation). The processor 730 may be an example of a single processor or multiple processors. For example, the device 705 may include one or more processors 730.

The data object manager 720 may support generating an output data object in accordance with examples as disclosed herein. For example, the data object manager 720 may be configured to support receiving, via a cloud-based platform, first user input including a request for generation of the output data object that is to include a set of multiple responses to a prompt. The data object manager 720 may be configured to support generating, at a processing layer of the cloud-based platform, the prompt based on the first user input and a prompt appendix that defines a response format for the set of multiple responses to the prompt that are to be generated by a large language model (LLM), the prompt appendix further defining a set of multiple response types to which the LLM is to map individual responses of the set of multiple responses and including an instruction to generate the set of multiple responses in the output data object in accordance with the plurality of response types. The data object manager 720 may be configured to support transmitting the prompt from the processing layer to the LLM. The data object manager 720 may be configured to support receiving, from the LLM at the processing layer, the set of multiple responses formatted in the response format. The data object manager 720 may be configured to support generating the output data object that includes the set of multiple responses based on a mapping between one or more elements of the response format and one or more elements of a data format corresponding to the output data object.

By including or configuring the data object manager 720 in accordance with examples as described herein, the device 705 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

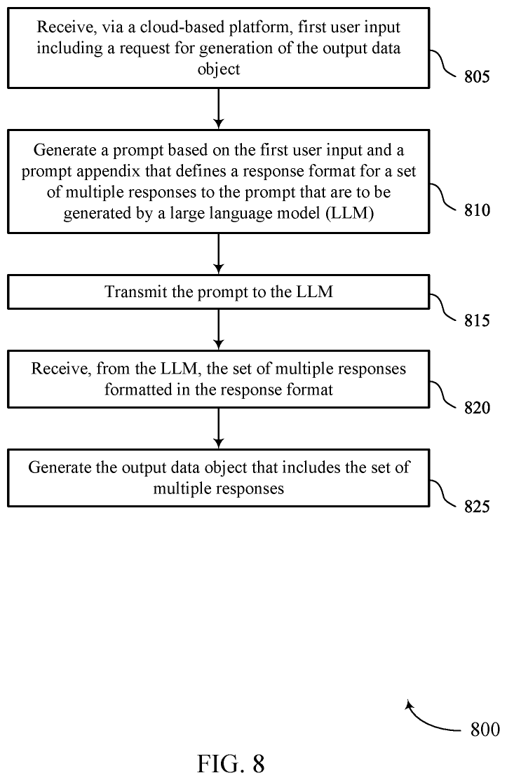

FIG. 8 shows a flowchart illustrating a method 800 that supports large language model data object generation in accordance with aspects of the present disclosure. The operations of the method 800 may be implemented by an application server or its components as described herein. For example, the operations of the method 800 may be performed by an application server as described with reference to FIGS. 1 through 7. In some examples, an application server may execute a set of instructions to control the functional elements of the application server to perform the described functions. Additionally, or alternatively, the application server may perform aspects of the described functions using special-purpose hardware.

At 805, the method may include receiving, via a cloud-based platform, first user input including a request for generation of the output data object that is to include a set of multiple responses to a prompt. The operations of block 805 may be performed in accordance with examples as disclosed herein. In some examples, aspects of the operations of 805 may be performed by a user input component 625 as described with reference to FIG. 6.

At 810, the method may include generating, at a processing layer of the cloud-based platform, the prompt based on the first user input and a prompt appendix that defines a response format for the set of multiple responses to the prompt that are to be generated by a large language model (LLM), the prompt appendix further defining a set of multiple response types to which the LLM is to map individual responses of the set of multiple responses and including an instruction to generate the set of multiple responses in the output data object in accordance with the plurality of response types. The operations of block 810 may be performed in accordance with examples as disclosed herein. In some examples, aspects of the operations of 810 may be performed by a prompt generation component 630 as described with reference to FIG. 6.

At 815, the method may include transmitting the prompt from the processing layer to the LLM. The operations of block 815 may be performed in accordance with examples as disclosed herein. In some examples, aspects of the operations of 815 may be performed by an LLM interface component 635 as described with reference to FIG. 6.

At 820, the method may include receiving, from the LLM at the processing layer, the set of multiple responses formatted in the response format. The operations of block 820 may be performed in accordance with examples as disclosed herein. In some examples, aspects of the operations of 820 may be performed by an LLM interface component 635 as described with reference to FIG. 6.

At 825, the method may include generating the output data object that includes the set of multiple responses based on a mapping between one or more elements of the response format and one or more elements of a data format corresponding to the output data object. The operations of block 825 may be performed in accordance with examples as disclosed herein. In some examples, aspects of the operations of 825 may be performed by a data object generation component 640 as described with reference to FIG. 6.

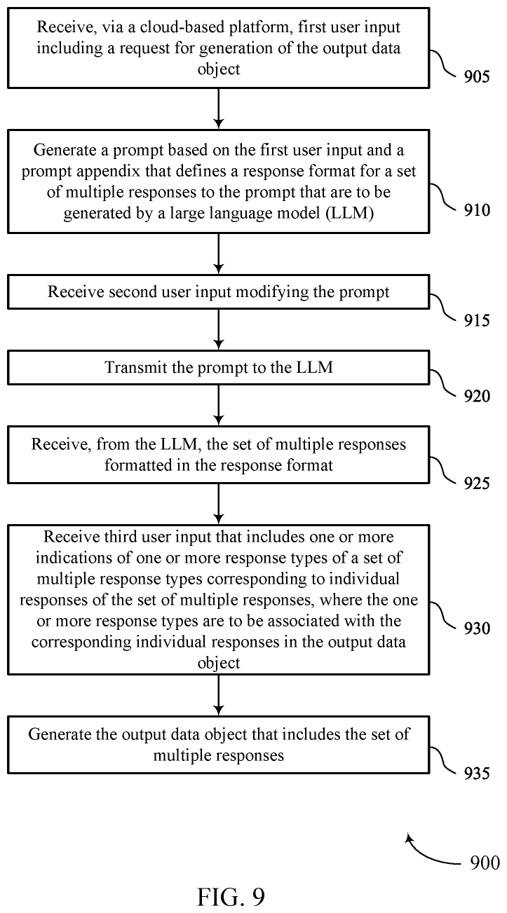

FIG. 9 shows a flowchart illustrating a method 900 that supports large language model data object generation in accordance with aspects of the present disclosure. The operations of the method 900 may be implemented by an application server or its components as described herein. For example, the operations of the method 900 may be performed by an application server as described with reference to FIGS. 1 through 7. In some examples, an application server may execute a set of instructions to control the functional elements of the application server to perform the described functions. Additionally, or alternatively, the application server may perform aspects of the described functions using special-purpose hardware.

At 905, the method may include receiving, via a cloud-based platform, first user input including a request for generation of the output data object that is to include a set of multiple responses to a prompt. The operations of block 905 may be performed in accordance with examples as disclosed herein. In some examples, aspects of the operations of 905 may be performed by a user input component 625 as described with reference to FIG. 6.

At 910, the method may include generating, at a processing layer of the cloud-based platform, the prompt based on the first user input and a prompt appendix that defines a response format for the set of multiple responses to the prompt that are to be generated by a large language model (LLM), the prompt appendix further defining a set of multiple response types to which the LLM is to map individual responses of the set of multiple responses and including an instruction to generate the set of multiple responses in the output data object in accordance with the plurality of response types. The operations of block 910 may be performed in accordance with examples as disclosed herein. In some examples, aspects of the operations of 910 may be performed by a prompt generation component 630 as described with reference to FIG. 6.

At 915, the method may include receiving second user input modifying the prompt. The operations of block 915 may be performed in accordance with examples as disclosed herein. In some examples, aspects of the operations of 915 may be performed by a prompt generation component 630 as described with reference to FIG. 6.

At 920, the method may include transmitting the prompt from the processing layer to the LLM. The operations of block 920 may be performed in accordance with examples as disclosed herein. In some examples, aspects of the operations of 920 may be performed by an LLM interface component 635 as described with reference to FIG. 6.

At 925, the method may include receiving, from the LLM at the processing layer, the set of multiple responses formatted in the response format. The operations of block 925 may be performed in accordance with examples as disclosed herein. In some examples, aspects of the operations of 925 may be performed by an LLM interface component 635 as described with reference to FIG. 6.

At 930, the method may include receiving third user input that includes one or more indications of one or more selected response types of the set of multiple response types corresponding to individual responses of the set of multiple responses, where the one or more selected response types are to be associated with the corresponding individual responses in the output data object. The operations of block 930 may be performed in accordance with examples as disclosed herein. In some examples, aspects of the operations of 930 may be performed by a response type component 645 as described with reference to FIG. 6.

At 935, the method may include generating the output data object that includes the set of multiple responses based on a mapping between one or more elements of the response format and one or more elements of a data format corresponding to the output data object. The operations of block 935 may be performed in accordance with examples as disclosed herein. In some examples, aspects of the operations of 935 may be performed by a data object generation component 640 as described with reference to FIG. 6.

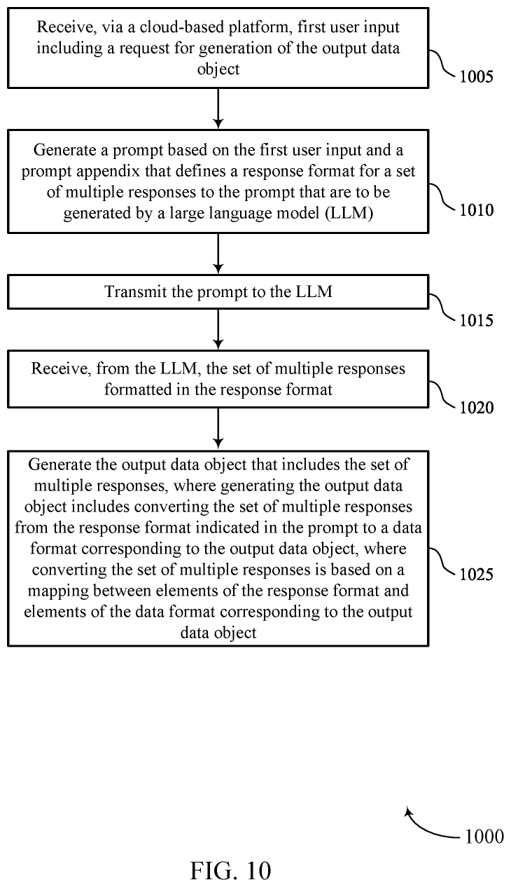

FIG. 10 shows a flowchart illustrating a method 1000 that supports large language model data object generation in accordance with aspects of the present disclosure. The operations of the method 1000 may be implemented by an application server or its components as described herein. For example, the operations of the method 1000 may be performed by an application server as described with reference to FIGS. 1 through 7. In some examples, an application server may execute a set of instructions to control the functional elements of the application server to perform the described functions. Additionally, or alternatively, the application server may perform aspects of the described functions using special-purpose hardware.

At 1005, the method may include receiving, via a cloud-based platform, first user input including a request for generation of the output data object that is to include a set of multiple responses to a prompt. The operations of block 1005 may be performed in accordance with examples as disclosed herein. In some examples, aspects of the operations of 1005 may be performed by a user input component 625 as described with reference to FIG. 6.

At 1010, the method may include generating, at a processing layer of the cloud-based platform, the prompt based on the first user input and a prompt appendix that defines a response format for the set of multiple responses to the prompt that are to be generated by a large language model (LLM), the prompt appendix further defining a set of multiple response types to which the LLM is to map individual responses of the set of multiple responses and including an instruction to generate the set of multiple responses in the output data object in accordance with the plurality of response types. The operations of block 1010 may be performed in accordance with examples as disclosed herein. In some examples, aspects of the operations of 1010 may be performed by a prompt generation component 630 as described with reference to FIG. 6.

At 1015, the method may include transmitting the prompt from the processing layer to the LLM. The operations of block 1015 may be performed in accordance with examples as disclosed herein. In some examples, aspects of the operations of 1015 may be performed by an LLM interface component 635 as described with reference to FIG. 6.

At 1020, the method may include receiving, from the LLM at the processing layer, the set of multiple responses formatted in the response format. The operations of block 1020 may be performed in accordance with examples as disclosed herein. In some examples, aspects of the operations of 1020 may be performed by an LLM interface component 635 as described with reference to FIG. 6.

At 1025, the method may include generating the output data object that includes the set of multiple responses based on a mapping between one or more elements of the response format and one or more elements of a data format corresponding to the output data object, where generating the output data object includes converting the set of multiple responses to the data format corresponding to the output data object based on the mapping between the one or more elements of the response format and the one or more elements of the data format. The operations of block 1025 may be performed in accordance with examples as disclosed herein. In some examples, aspects of the operations of 1025 may be performed by a data object generation component 640 as described with reference to FIG. 6, a format conversion component 650 as described with reference to FIG. 6, or any combination thereof.

A method for generating an output data object by an apparatus is described. The method may include receiving, via a cloud-based platform, first user input including a request for generation of the output data object that is to include a set of multiple responses to a prompt, generating, at a processing layer of the cloud-based platform, the prompt based on the first user input and a prompt appendix that defines a response format for the set of multiple responses to the prompt that are to be generated by a large language model (LLM), the prompt appendix further defining a set of multiple response types to which the LLM is to map individual responses of the set of multiple responses and including an instruction to generate the set of multiple responses in the output data object in accordance with the plurality of response types, transmitting the prompt from the processing layer to the LLM, receiving, from the LLM at the processing layer, the set of multiple responses formatted in the response format, and generating the output data object that includes the set of multiple responses based on a mapping between one or more elements of the response format and one or more elements of a data format corresponding to the output data object.

An apparatus for generating an output data object is described. The apparatus may include one or more memories storing processor executable code, and one or more processors coupled with the one or more memories. The one or more processors may individually or collectively operable to execute the code to cause the apparatus to receive, via a cloud-based platform, first user input including a request for generation of the output data object that is to include a set of multiple responses to a prompt, generate, at a processing layer of the cloud-based platform, the prompt based on the first user input and a prompt appendix that defines a response format for the set of multiple responses to the prompt that are to be generated by a large language model (LLM), the prompt appendix further defining a set of multiple response types to which the LLM is to map individual responses of the set of multiple responses and including an instruction to generate the set of multiple responses in the output data object in accordance with the plurality of response types, transmit the prompt from the processing layer to the LLM, receive, from the LLM at the processing layer, the set of multiple responses formatted in the response format, and generate the output data object that includes the set of multiple responses based on a mapping between one or more elements of the response format and one or more elements of a data format corresponding to the output data object.

Another apparatus for generating an output data object is described. The apparatus may include means for receiving, via a cloud-based platform, first user input including a request for generation of the output data object that is to include a set of multiple responses to a prompt, means for generating, at a processing layer of the cloud-based platform, the prompt based on the first user input and a prompt appendix that defines a response format for the set of multiple responses to the prompt that are to be generated by a large language model (LLM), the prompt appendix further defining a set of multiple response types to which the LLM is to map individual responses of the set of multiple responses and including an instruction to generate the set of multiple responses in the output data object in accordance with the plurality of response types, means for transmitting the prompt from the processing layer to the LLM, means for receiving, from the LLM at the processing layer, the set of multiple responses formatted in the response format, and means for generating the output data object that includes the set of multiple responses based on a mapping between one or more elements of the response format and one or more elements of a data format corresponding to the output data object.

A non-transitory computer-readable medium storing code for generating an output data object is described. The code may include instructions executable by one or more processors to receive, via a cloud-based platform, first user input including a request for generation of the output data object that is to include a set of multiple responses to a prompt, generate, at a processing layer of the cloud-based platform, the prompt based on the first user input and a prompt appendix that defines a response format for the set of multiple responses to the prompt that are to be generated by a large language model (LLM), the prompt appendix further defining a set of multiple response types to which the LLM is to map individual responses of the set of multiple responses and including an instruction to generate the set of multiple responses in the output data object in accordance with the plurality of response types, transmit the prompt from the processing layer to the LLM, receive, from the LLM at the processing layer, the set of multiple responses formatted in the response format, and generate the output data object that includes the set of multiple responses based on a mapping between one or more elements of the response format and one or more elements of a data format corresponding to the output data object.

In some examples of the method, apparatus, and non-transitory computer-readable medium described herein, the response format includes a response name field, a response type field, a help text field, an optionality field, or any combination thereof.

In some examples of the method, apparatus, and non-transitory computer-readable medium described herein, the first user input further includes an indication of an output data object type, an indication of a quantity of requested responses, an indication of one or more metrics associated with the set of multiple responses, an indication of an industry to be associated with the set of multiple responses, an indication of a geographic region to be associated with the set of multiple responses, or any combination thereof.

Some examples of the method, apparatus, and non-transitory computer-readable medium described herein may further include operations, features, means, or instructions for receiving second user input modifying the prompt.

Some examples of the method, apparatus, and non-transitory computer-readable medium described herein may further include operations, features, means, or instructions for receiving third user input that includes one or more indications of one or more selected response types of the set of multiple response types corresponding to individual responses of the set of multiple responses, where the one or more selected response types may be to be associated with the corresponding individual responses in the output data object.

In some examples of the method, apparatus, and non-transitory computer-readable medium described herein, the set of multiple response types includes a single selection response type, a multiple selection response type, a picklist response type, a net promoter score response type, a customer satisfaction response type, a text entry response type, or any combination thereof.

Some examples of the method, apparatus, and non-transitory computer-readable medium described herein may further include operations, features, means, or instructions for generating the output data object includes converting the set of multiple responses to the data format corresponding to the output data object based on the mapping between the one or more elements of the response format and the one or more elements of the data format.

In some examples of the method, apparatus, and non-transitory computer-readable medium described herein, the prompt appendix includes a request to map each of the set of multiple responses to one or more response types of the set of multiple response types.

Some examples of the method, apparatus, and non-transitory computer-readable medium described herein may further include operations, features, means, or instructions for training the LLM with training data including feedback information associated with previously-generated output data objects, a set of multiple translations of previously-generated output data objects, customer data, customer relationship management software data, or any combination thereof.

In some examples of the method, apparatus, and non-transitory computer-readable medium described herein, the prompt further indicates a target language to which the set of multiple responses may be to be translated by the LLM and the set of multiple responses include information expressed in the target language.

In some examples of the method, apparatus, and non-transitory computer-readable medium described herein, the set of multiple responses includes survey questions, the output data object includes a survey data object, or both.

The following provides an overview of aspects of the present disclosure:

Aspect 1: A method for generating an output data object, comprising: receiving, via a cloud-based platform, first user input comprising a request for generation of the output data object that is to comprise a plurality of responses to a prompt: generating, at a processing layer of the cloud-based platform, the prompt based at least in part on the first user input and a prompt appendix that defines a response format for the plurality of responses to the prompt that are to be generated by a large language model (LLM), the prompt appendix further defining a plurality of response types to which the LLM is to map individual responses of the plurality of responses and including an instruction to generate the plurality of responses in the output data object in accordance with the plurality of response types: transmitting the prompt from the processing layer to the LLM: receiving, from the LLM at the processing layer, the plurality of responses formatted in the response format; and generating the output data object that comprises the plurality of responses based at least in part on a mapping between one or more elements of the response format and one or more elements of a data format corresponding to the output data object.

Aspect 2: The method of aspect 1, wherein the response format comprises a response name field, a response type field, a help text field, an optionality field, or any combination thereof.

Aspect 3: The method of any of aspects 1 through 2, wherein the first user input further comprises an indication of an output data object type, an indication of a quantity of requested responses, an indication of one or more metrics associated with the plurality of responses, an indication of an industry to be associated with the plurality of responses, an indication of a geographic region to be associated with the plurality of responses, or any combination thereof.

Aspect 4: The method of any of aspects 1 through 3, further comprising: receiving second user input modifying the prompt.

Aspect 5: The method of any of aspects 1 through 4, further comprising: receiving third user input that comprises one or more indications of one or more selected response types of the plurality of response types corresponding to individual responses of the plurality of responses, wherein the one or more selected response types are to be associated with the corresponding individual responses in the output data object.

Aspect 6: The method of aspect 5, wherein the plurality of response types comprises a single selection response type, a multiple selection response type, a picklist response type, a net promoter score response type, a customer satisfaction response type, a text entry response type, or any combination thereof.

Aspect 7: The method of any of aspects 1 through 6, wherein generating the output data object comprises converting the plurality of responses to the data format corresponding to the output data object based at least in part on the mapping between the one or more elements of the response format and the one or more elements of the data format.

Aspect 8: The method of any of aspects 1 through 7, wherein the prompt appendix comprises a request to map each of the plurality of responses to one or more response types of the plurality of response types.

Aspect 9: The method of any of aspects 1 through 8, further comprising: training the LLM with training data comprising feedback information associated with previously-generated output data objects, a plurality of translations of previously-generated output data objects, customer data, customer relationship management software data, or any combination thereof.

Aspect 10: The method of any of aspects 1 through 9, wherein the prompt further indicates a target language to which the plurality of responses is to be translated by the LLM; and the plurality of responses comprise information expressed in the target language.

Aspect 11: The method of any of aspects 1 through 10, wherein the plurality of responses comprises survey questions, the output data object comprises a survey data object, or both.

Aspect 12: An apparatus for generating an output data object, comprising one or more memories storing processor-executable code, and one or more processors coupled with the one or more memories and individually or collectively operable to execute the code to cause the apparatus to perform a method of any of aspects 1 through 11.

Aspect 13: An apparatus for generating an output data object, comprising at least one means for performing a method of any of aspects 1 through 11.

Aspect 14: A non-transitory computer-readable medium storing code for generating an output data object, the code comprising instructions executable by one or more processors to perform a method of any of aspects 1 through 11.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for generating an output data object, comprising:
receiving, via a cloud-based platform, first user input comprising a request for generation of the output data object that is to comprise a plurality of responses to a prompt;
generating, at a processing layer of the cloud-based platform, the prompt based at least in part on the first user input and a prompt appendix that defines a response format for the plurality of responses to the prompt that are to be generated by a large language model (LLM), the prompt appendix further defining a plurality of response types to which the LLM is to map individual responses of the plurality of responses and including an instruction to generate the plurality of responses in the output data object in accordance with the plurality of response types;
transmitting the prompt from the processing layer to the LLM;
receiving, from the LLM at the processing layer, the plurality of responses formatted in the response format; and
generating the output data object that comprises the plurality of responses based at least in part on a mapping between one or more elements of the response format and one or more elements of a data format corresponding to the output data object.

2. The method of claim 1, wherein the response format comprises a response name field, a response type field, a help text field, an optionality field, or any combination thereof.

3. The method of claim 1, wherein the first user input further comprises an indication of an output data object type, an indication of a quantity of requested responses, an indication of one or more metrics associated with the plurality of responses, an indication of an industry to be associated with the plurality of responses, an indication of a geographic region to be associated with the plurality of responses, or any combination thereof.

4. The method of claim 1, further comprising:
receiving second user input modifying the prompt.

5. The method of claim 1, further comprising:
receiving third user input that comprises one or more indications of one or more selected response types of the plurality of response types corresponding to individual responses of the plurality of responses, wherein the one or more selected response types are to be associated with the corresponding individual responses in the output data object.

6. The method of claim 5, wherein the plurality of response types comprises a single selection response type, a multiple selection response type, a picklist response type, a net promoter score response type, a customer satisfaction response type, a text entry response type, or any combination thereof.

7. The method of claim 1, wherein generating the output data object comprises converting the plurality of responses to the data format corresponding to the output data object based at least in part on the mapping between the one or more elements of the response format and the one or more elements of the data format.

8. The method of claim 1, wherein the prompt appendix comprises a request to map each of the plurality of responses to one or more response types of the plurality of response types.

9. The method of claim 1, further comprising:
training the LLM with training data comprising feedback information associated with previously-generated output data objects, a plurality of translations of previously-generated output data objects, customer data, customer relationship management software data, or any combination thereof.

10. The method of claim 1, wherein:
the prompt further indicates a target language to which the plurality of responses is to be translated by the LLM; and
the plurality of responses comprise information expressed in the target language.

11. The method of claim 1, wherein the plurality of responses comprises survey questions, the output data object comprises a survey data object, or both.

12. An apparatus for generating an output data object, comprising:
one or more memories storing processor-executable code; and
one or more processors coupled with the one or more memories and individually or collectively operable to execute the code to cause the apparatus to:
receive, via a cloud-based platform, first user input comprising a request for generation of the output data object that is to comprise a plurality of responses to a prompt;
generate, at a processing layer of the cloud-based platform, the prompt based at least in part on the first user input and a prompt appendix that defines a response format for the plurality of responses to the prompt that are to be generated by a large language model (LLM), the prompt appendix further defining a plurality of response types to which the LLM is to map individual responses of the plurality of responses and including an instruction to generate the plurality of responses in the output data object in accordance with the plurality of response types:
transmit the prompt from the processing layer to the LLM;
receive, from the LLM at the processing layer, the plurality of responses formatted in the response format; and
generate the output data object that comprises the plurality of responses based at least in part on a mapping between one or more elements of the response format and one or more elements of a data format corresponding to the output data object.

13. The apparatus of claim 12, wherein the response format comprises a response name field, a response type field, a help text field, an optionality field, or any combination thereof.

14. The apparatus of claim 12, wherein the first user input further comprises an indication of an output data object type, an indication of a quantity of requested responses, an indication of one or more metrics associated with the plurality of responses, an indication of an industry to be associated with the plurality of responses, an indication of a geographic region to be associated with the plurality of responses, or any combination thereof.

15. The apparatus of claim 12, wherein the one or more processors are individually or collectively further operable to execute the code to cause the apparatus to:
receive second user input modifying the prompt.

16. The apparatus of claim 12, wherein the one or more processors are individually or collectively further operable to execute the code to cause the apparatus to:
receive third user input that comprises one or more indications of one or more selected response types of the plurality of response types corresponding to individual responses of the plurality of responses, wherein the one or more selected response types are to be associated with the corresponding individual responses in the output data object.

17. The apparatus of claim 16, wherein the plurality of response types comprises a single selection response type, a multiple selection response type, a picklist response type, a net promoter score response type, a customer satisfaction response type, a text entry response type, or any combination thereof.

18. The apparatus of claim 12, wherein generating the output data object comprises converting the plurality of responses to the data format corresponding to the output data object based at least in part on the mapping between the one or more elements of the response format and the one or more elements of the data format.

19. The apparatus of claim 12, wherein the prompt appendix comprises a request to map each of the plurality of responses to one or more response types of the plurality of response types.

20. A non-transitory computer-readable medium storing code for generating an output data object, the code comprising instructions executable by one or more processors to:
receive, via a cloud-based platform, first user input comprising a request for generation of the output data object that is to comprise a plurality of responses to a prompt;
generate, at a processing layer of the cloud-based platform, the prompt based at least in part on the first user input and a prompt appendix that defines a response format for the plurality of responses to the prompt that are to be generated by a large language model (LLM), the prompt appendix further defining a plurality of response types to which the LLM is to map individual responses of the plurality of responses and including an instruction to generate the plurality of responses in the output data object in accordance with the plurality of response types;
transmit the prompt from the processing layer to the LLM;
receive, from the LLM at the processing layer, the plurality of responses formatted in the response format; and
generate the output data object that comprises the plurality of responses based at least in part on a mapping between one or more elements of the response format and one or more elements of a data format corresponding to the output data object.
